(19) United States
(12) Patent Application Publication
(10) Pub. No.: US 2005/0262148 A1
(43) Pub. Date: Nov. 24, 2005

(54) Simplified, secure electronic project data exchange

(76) Inventor: Harold Hugh Davitt, Washington, DC (US)

Correspondence Address: HAROLD HUGH DAVITT, 905 M STREET, NW, WASHINGTON, DC, 20001, US

(21) Appl. No.: 11/119,812

(22) Filed: May 3, 2005

Related U.S. Application Data
(60) Provisional application No. 60/567,148, filed on May 3, 2004.

(51) Int. Cl. G06F 17/00

(52) U.S. Cl. 707/104.1

(57) ABSTRACT

A system and method of exchanging project data between disparate levels of users, independent of whether the user is a client or professional, or which operating system level or software is employed.

### RELATED APPLICATION

This application claims priority from U.S. provisional Application Ser. No. 60/567,148, filed May 3, 2004, which is hereby incorporated by reference.

### FIELD OF INVENTION

The present invention relates generally to the field of secure project data exchange. More particularly, the present invention relates to a system and method of exchanging electronic project data and project data parameters between one or more disparate levels of users of the same or dissimilar software.

### BACKGROUND OF INVENTION

Users of standard commercially available computer-based applications, such as accounting packages, frequently need to exchange project data with off-site users. Since the data is often very sensitive, as well as voluminous and scattered in many files and directories, conventional methods of electronic transfer, such as email or remote entry to a user's computer, are not acceptable. Such methods are generally not acceptable because they are too cumbersome for the ordinary user and lack proper security and audit trails.

In some cases, complex computer programs or scripts are written for individual (large) users. However, these scripts are generally difficult and/or costly to customize to the varieties of data storage, even for the same application software, since the user may have different release levels, different application options activated, and variable data locations in networked systems.

For example, where data transfer procedures using File Transfer Protocol (FTP), compression and encryption are developed for non-expert computer users, it is often difficult for these users to build the a transmittal package the same way twice, even assuming the same users have good documentation. Audit trails, rollback protection, data security and compression are so cumbersome as to be impossible to implement in a script for the ordinary computer user in the general case.

When application users are only minimally familiar with the concepts of files and data location and/or have difficulty attaching files to an email transmission, the data exchange problem is often solved by site visits by the application data reviewer.

While such visits are useful, site-specific customized scripts implemented for the ordinary user to exchange project data electronically usually requires the ongoing availability of a computer specialist both for set-up and adjustment to changing hardware and software configuration changes. In addition, a new release of the project's application software may easily render the script useless.

Furthermore, many of the data exchanges now handled by FTP transmission are between users with a common information technology function, such as users belonging to the same corporation. The rental and management of FTP space between users without this common bond is difficult, and can be a serious barrier to the use of FTP data exchange.

One existing solution to electronic project data exchange between users with a computer application only in common, is allowing remote access to the user's computer via the Internet. However, a major drawback of this solution is slow speed or response. In addition, this solution creates synchronization problems (i.e. data as of a particular cutoff date, such as the end of the month), and is unacceptable to security conscious users.

### SUMMARY OF INVENTION

The present invention is a customizable, user-friendly point and click system for exchanging project data between disparate levels of users, independent of whether the user is a client, professional or administrator, or which operating system level or software is employed. This is achieved in part by simplifying operations in the areas of transmission, configuration/user interface, audit trails/event history, billing, system/space management and installation.

As described in further detail below, the invention's system and method for efficient project data transfer concern the interchange of project data from one user to another including data compression for speed, encryption for security, audit trails for historical tracking, rollback protection, and simplicity for ordinary users who are connected only by a communications network, such as the internet. It is particularly relevant for situations where the same group of users of a computer application exchange data on a regular basis, such as monthly reviews of bookkeeping data by an accounting professional, though not so limited. However, the invention is also advantageous to the user concerned with a single application and that has minimal needs, such as sending and receiving data for one or more of a small number of projects. Client users may send and receive multiple projects.

For users exchanging project data, implementation of the present invention is simple, fast and secure including across personal computers with different operating systems (preferably Microsoft Windows®) and user application packages, including their various release levels. In a preferred embodiment, the present invention is self-contained, requiring no particular level of the Windows operating system beyond Windows 98.

The present invention is also advantageous to the user tasked with reviewing and managing data from two or more clients.

From experience and customer feedback, the inventor has developed simplifying operations that make project data transfer via FTP simple and virtually foolproof for unsophisticated users of software application by, for example, providing a simplified user interface; providing supporting software that handles the compression, encryption and transmission of project data; and providing automatic recovery attempts from transmission problems with user intervention.

Employing FTP lockboxes as an intermediary transfer mechanism provides faster data transfer for the user than HTTP protocol and allows asynchronous actions by sender and receiver. It further avoids any interference caused by electronic mail overload and spam.

The present invention simplifies encryption for users by providing for their input by way of a positive integer within a specified range, and generating a 128-bit key in a non-linear fashion. Alternatively and optionally, more sophisticated users may supply their own Dynamic Link Library (DLL) to provide a private encryption method.

The present invention also provides configurable electronic alerts. For example, email notifications may be sent to a receiving party upon transmission, and to the transmitting party upon transmission to or retrieval from the FTP site.

Email may also be used as an alternate transmission vehicle if desired. However, this is slower than FTP and some email servers may restrict file volumes. Nevertheless, this option may be useful in the event that all FTP lockboxes are unavailable or if project data volume is relatively small.

Another transmission feature of the invention is its ability to transfer or backup the full personality (i.e. all project parameters and supporting databases) from one system to another, preferably on a password-protected basis. This is advantageous because it enables a professional or administrator, for example, to support clients for out-of-office use.

From a configuration standpoint, the present invention simplifies the setup of project definitions and parameters during installation and system upgrades, and encapsulates system complexities away from the user. A straightforward method of defining project data files and easily checking definitions for accuracy is provided, where project data files are preferably located within one or more directories on a local system and defined by, for example, file extent, exact file name, regular expression, or user-supplied algorithm.

A single, step-by-step configuration interface for each user is provided that addresses the three levels of users: client, professional, or space manager/administrator. This interface automatically checks each step without user intervention, from FTP parameters to project definition.

Another feature of the present invention is to remove and/or minimize day-to-day interaction of the space manager/administrator in operation of the invention. This is accomplished in part by setting space management parameters for each installation of the invention such that each client's information or project uses no more FTP and local space than permitted.

It should not be lost that the present invention allows for client-client project data exchange as well as client-professional exchanges. The invention enables users to define their own standard projects and place those choices on the appropriate invention menus.

In addition, the present invention provides the professional-user with a more powerful and comprehensive interface than the client-user by, for example, allowing selection of active clients, automatic recording of billable hours, and providing detailed analysis and review of data exchange with the client.

From an event history standpoint, the present invention provides audit trails of all user interactions with the system. This facilitates error diagnosis and correction, including error recovery and rollback for all project data transfers, as well as tracking billable hours. The invention also provides automatic backup as a byproduct of the interactions between professional and client. As a FTP lockbox is preferably at a third site, the most recent project data is also recoverable from there.

Notably, audit trails of actions in the system of the present invention are recorded whether successful or not. Examples of successful actions include connection to an FTP site or a data rollback. Examples of unsuccessful actions include a failed connection, or a local computer problem such as missing required support files or a failed system startup. Again, the audit trails are used for reporting, analysis and telephone problem resolution.

Accordingly, an advantage of the invention is backup of all data transfers and overwrites, and to provide simple rollback features for error recovery and usage of the application on previous data states. This backup feature may also be used as a record of a project's state ‘as of’ a particular time, such as at the end of an accounting period, whether any such save/backup options are built into a particular application or not. The invention may be used to backup a project data locally with such backup having a unique time-stamp; that is, one backup does not overwrite prior data. Automatic use of backup FTP sites in the event that the primary FTP site cannot be used, is also provided by the invention.

The invention also includes a receipt system so that each user may ascertain whether and when a receiver has downloaded a transmission.

An advantage of the invention's audit trails is that access to log data is available to all users so that most problems may be resolved through a telephone conversation with a help desk.

Because project definitions may become unsynchronized between users in the event of a system upgrade or reconfiguration, the present invention provides a warning to any user if an incoming project has a project description that does not conform to the local definition, and to provide recovery alternatives.

From a billing tracking/generation standpoint, the present invention provides the professional with reports on the time spent using the invention for each client and project. These reports may be printed or exported into spreadsheets or any desired format(s).

In addition, the invention substantially reduces or eliminates site visits to the client by the professional, thereby allowing the professional to service more clients.

From an overall system/space management standpoint, the present invention automates user space management so that proper levels of backup are maintained at client, professional and space manager (FTP) sites. This is advantageous to a space manager required to handle administrative tasks such as renting or reserving FTP space, allocating space, reviewing space usage and handling first-level questions and problems. Additionally, it provides notification of possible change in configuration to the professional or client sides of the invention including, for example, instances of re-installation of application software or changes of software to another system.

The invention also provides usage analysis by each user to the administrator/space manager, to include space and bandwidth used, frequency of data exchange, and turnaround of client data by the professional.

To achieve the above and other advantages, the present invention provides a computer program product that stores computer instructions thereon for instructing a computer to perform a process of simplifying transmission financial application data into a single keystoke. A computer or processor driven system, tangible medium including instructions thereon, and process is also provided.

There has thus been outlined, rather broadly, the important features of the invention in order that the detailed description thereof that follows may be better understood, and in order that the present contribution to the art may be better appreciated. Additional features of the invention will be described hereinafter and which will form the subject matter of the claims appended hereto.

It is to be understood that the invention is not limited in its application to the details of construction and to the arrangements of the components set forth in the following description or illustrated in the drawings. The current invention is capable of other embodiments and of being practiced and carried out in various ways. The conception of the present invention may readily be used as a basis for the designing of other structures, methods and systems for carrying out the several purposes of the present invention. Therefore, it is important that the claims be regarded as including such equivalent constructions insofar as they do not depart from the spirit and scope of the present invention. The terminology employed herein also is for the purpose of description and should not be regarded as limiting.

### BRIEF DESCRIPTION OF EMBODIMENTS

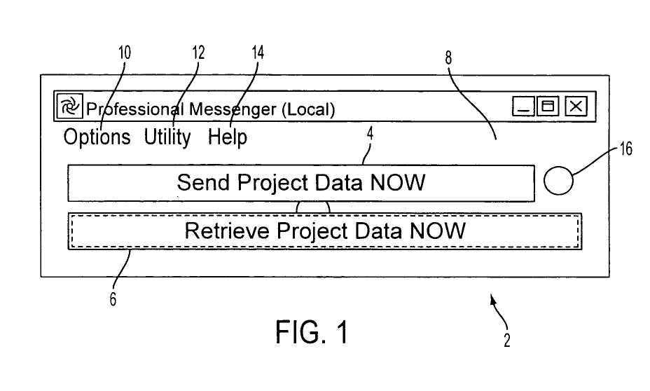

FIG. 1 is an illustration of a client-user interface in accordance with a preferred embodiment of the invention.

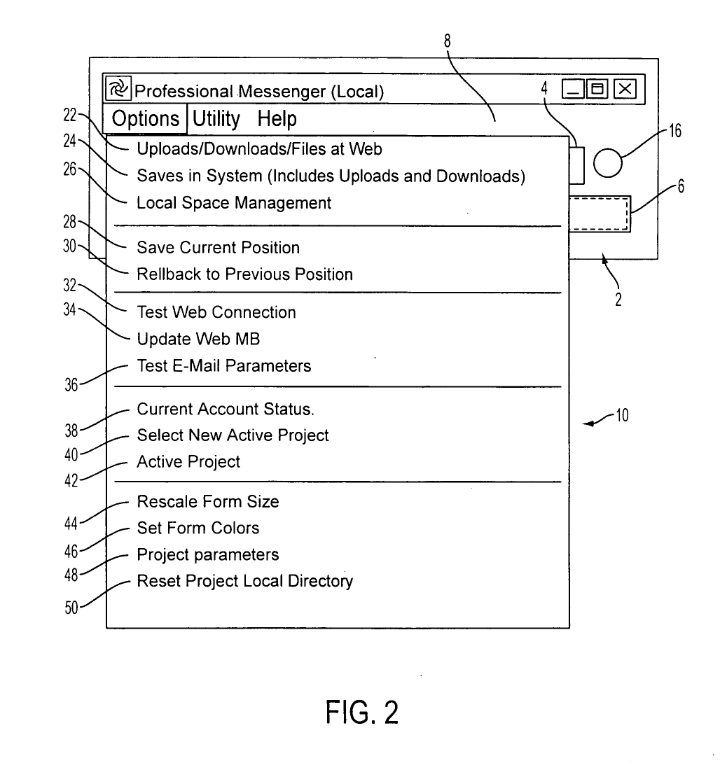

FIG. 2 is an illustration of an options drop down menu according to an embodiment of the invention.

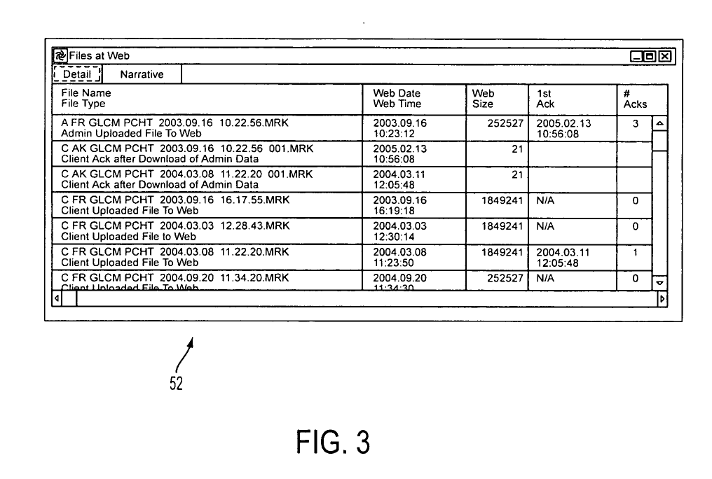

FIG. 3 is an illustration of transmissions listings of a project FTP lockbox according to an embodiment of the present invention.

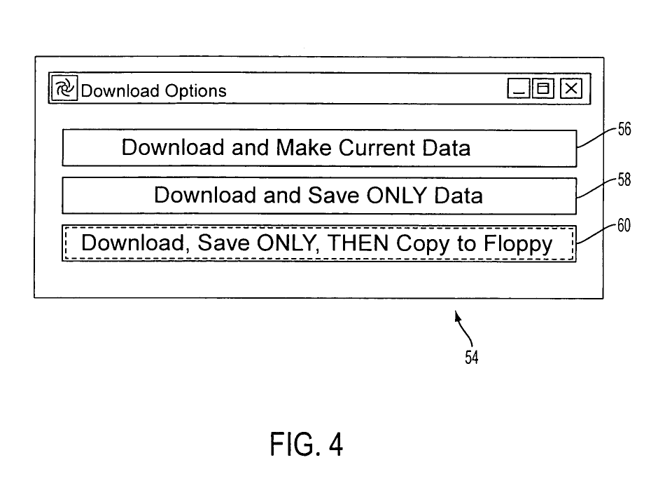

FIG. 4 is an illustration of a download options screen according to an embodiment of the present invention.

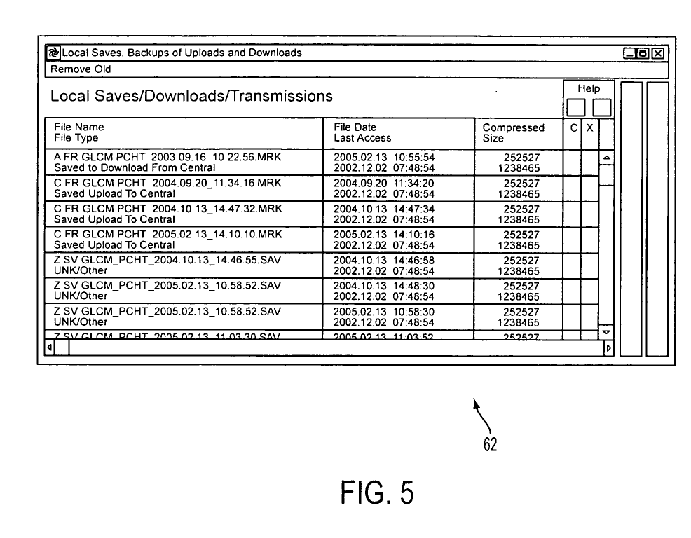

FIG. 5 is an illustration of a local save/rollback status screen according to an embodiment of the present invention.

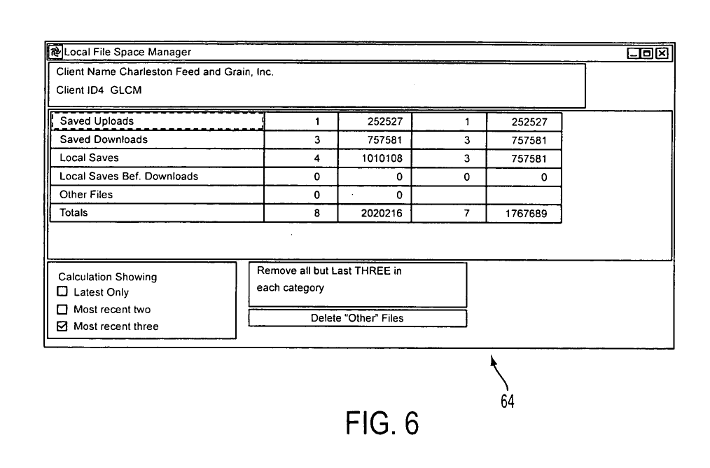

FIG. 6 is an illustration of a local space manager screen according to an embodiment of the present invention.

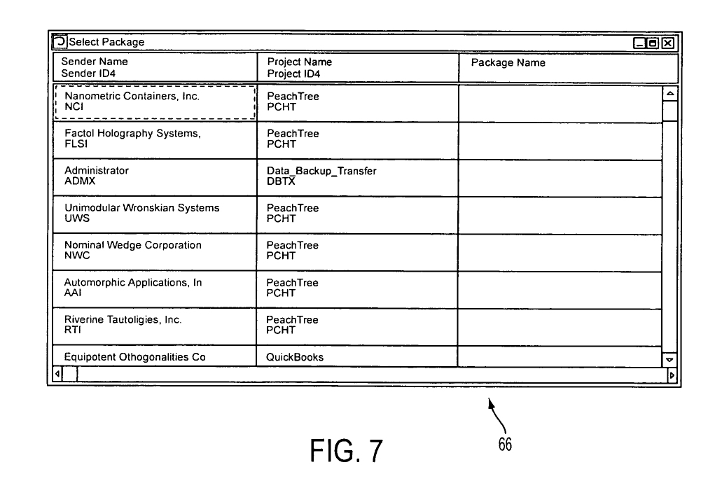

FIG. 7 is an illustration of an owner/project selection screen according to an embodiment of the present invention.

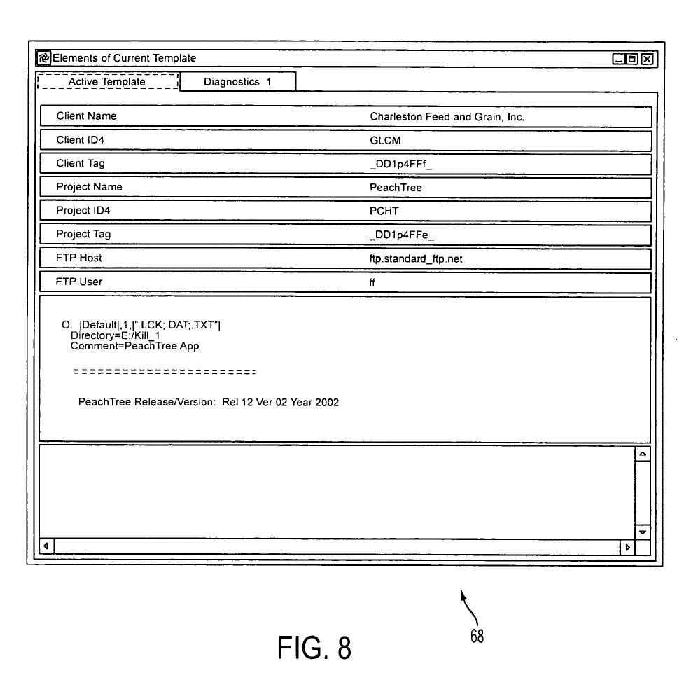

FIG. 8 is an illustration of a template definitions screen according to an embodiment of the present invention.

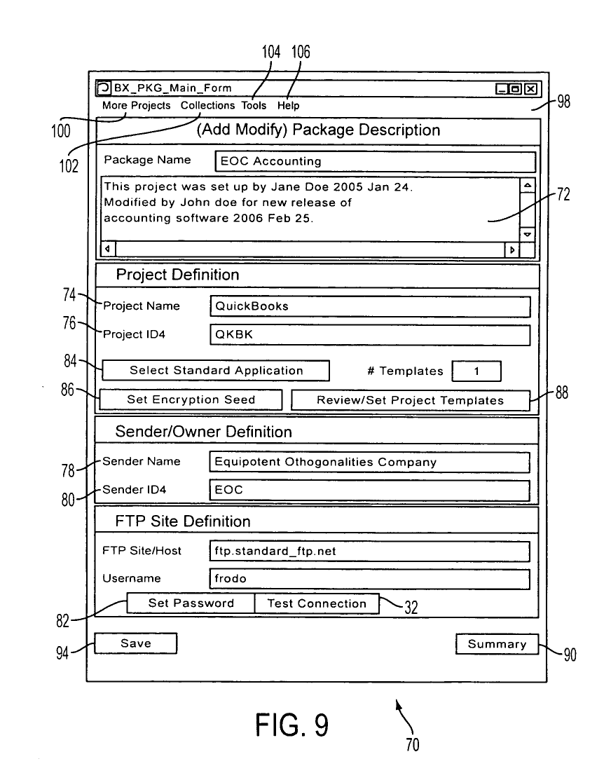

FIG. 9 is an illustration of a project setup screen according to an embodiment of the present invention.

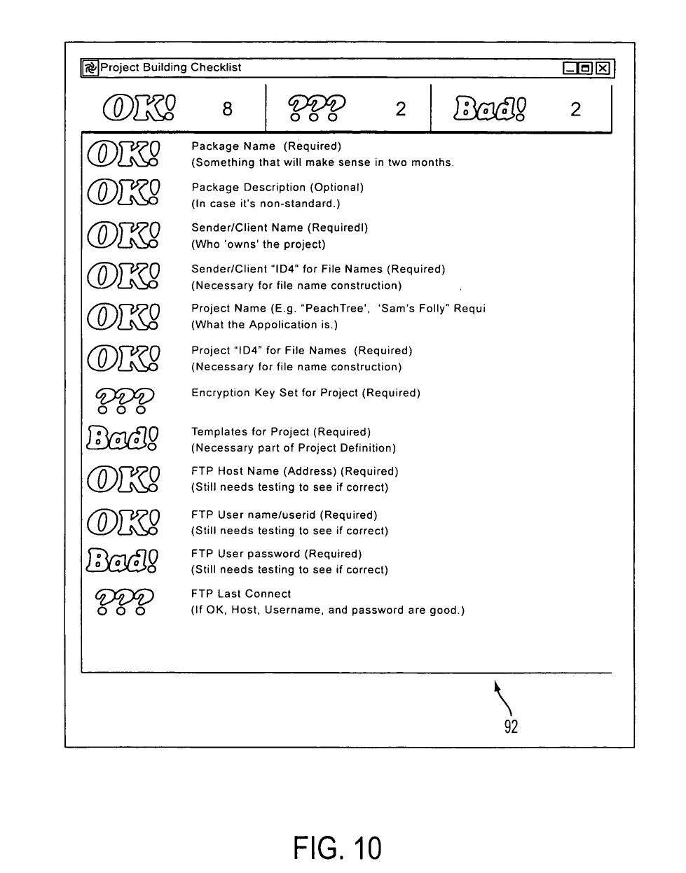

FIG. 10 is an illustration of a configuration review screen according to an embodiment of the present invention.

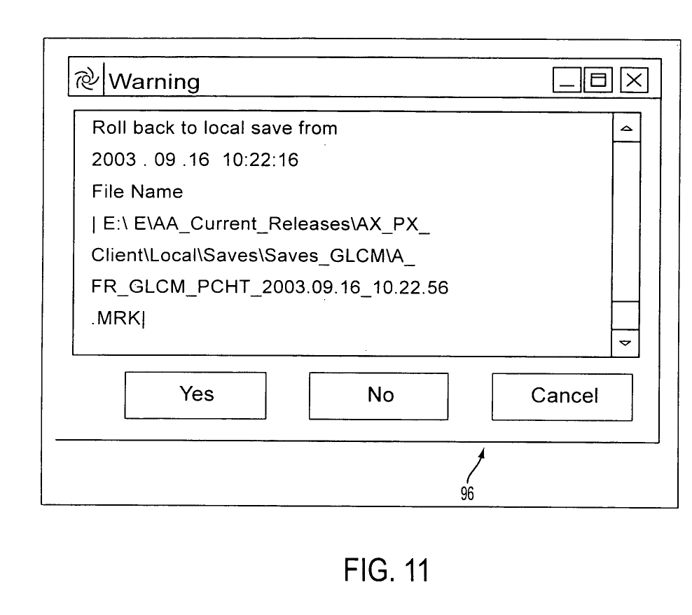

FIG. 11 is an illustration of a confirmation dialog according to an embodiment of the present invention.

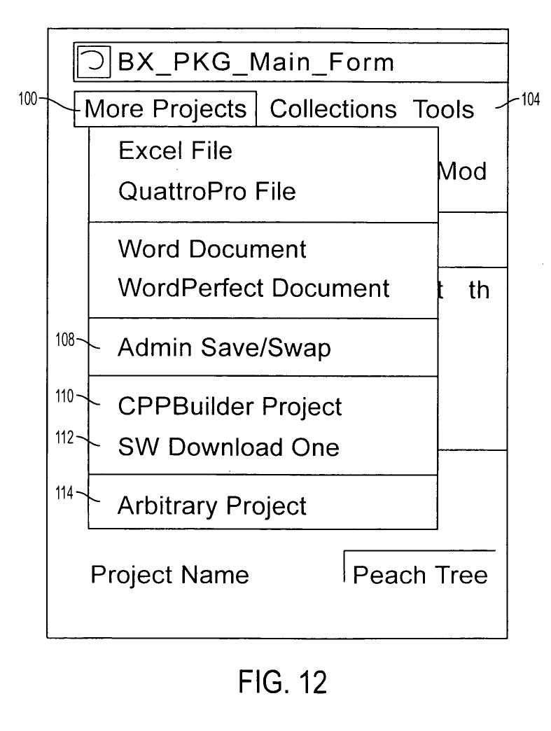

FIG. 12 is an illustration of a more projects drop down menu according to an embodiment of the present invention.

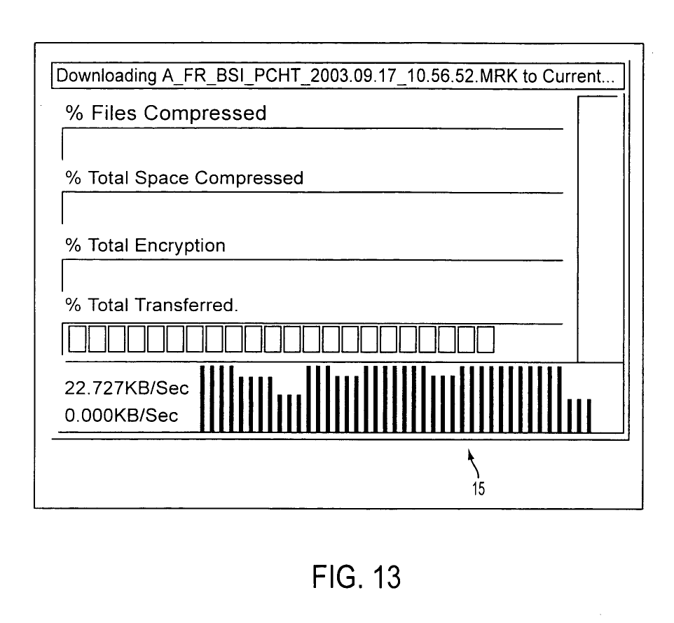

FIG. 13 is an illustration of a data transmit progress screen according to an embodiment of the present invention.

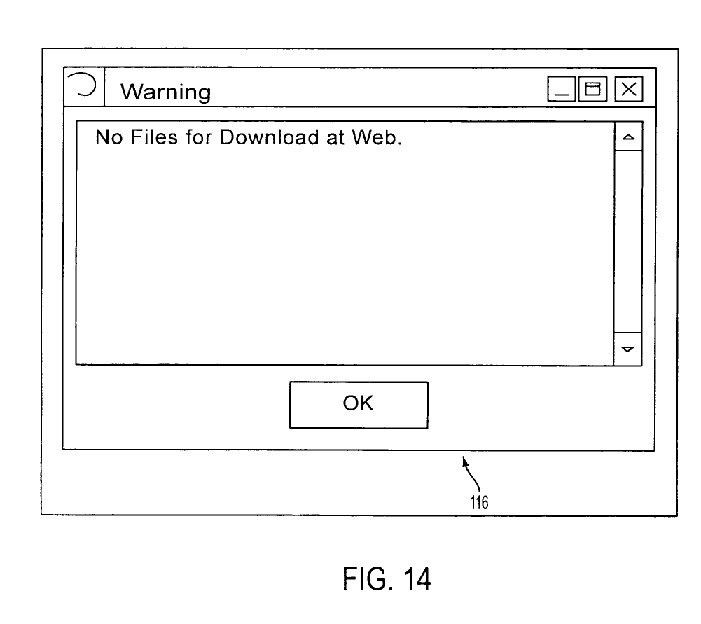

FIG. 14 is an illustration of a warning dialog according to an embodiment of the present invention.

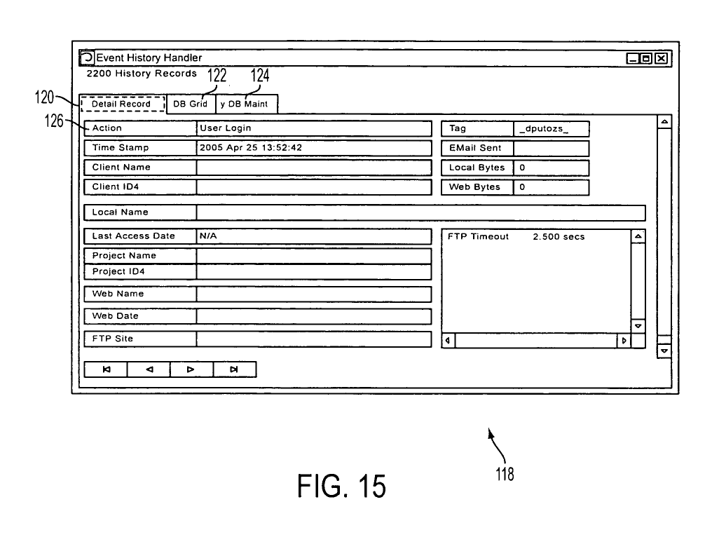

FIG. 15 is an illustration of a history detail display screen according to an embodiment of the present invention.

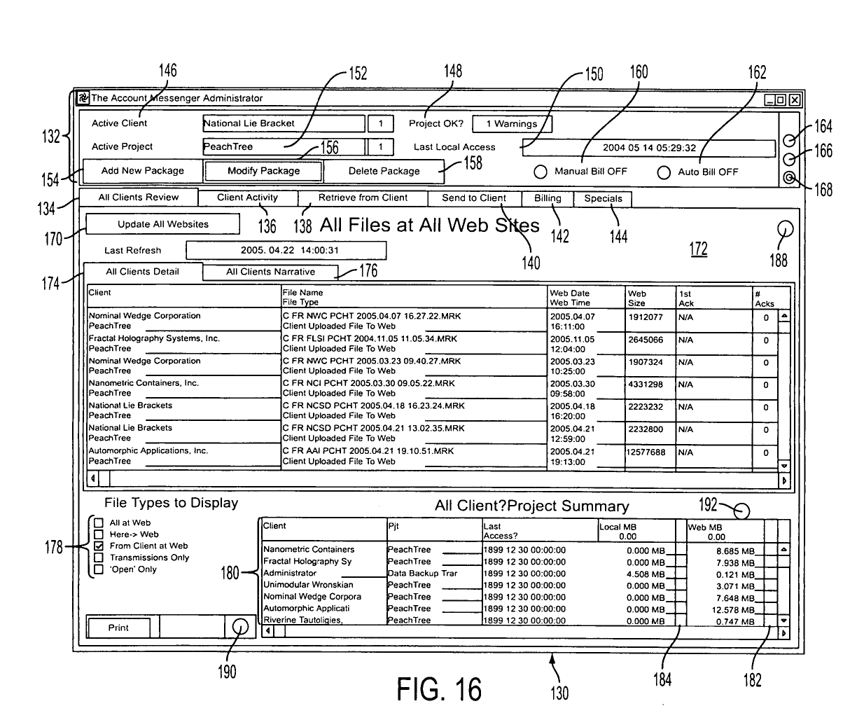

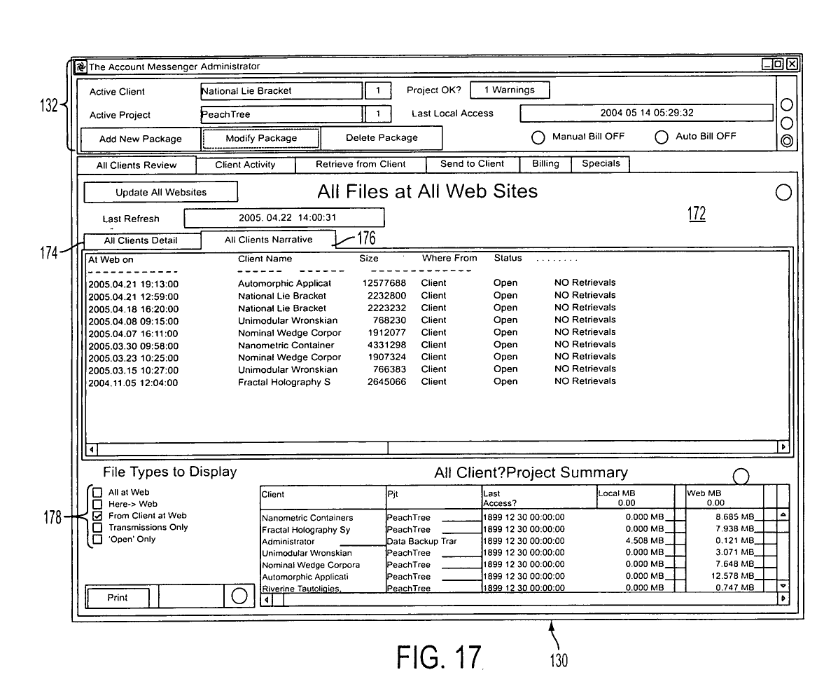

FIGS. 16 and 17 are illustrations of a professional user interface for all files according to an embodiment of the present invention.

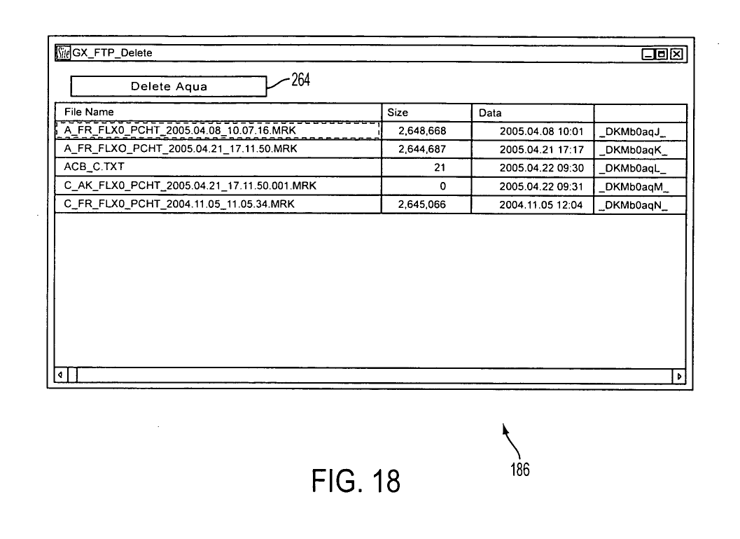

FIG. 18 is an illustration of a web space manager screen according to an embodiment of the present invention.

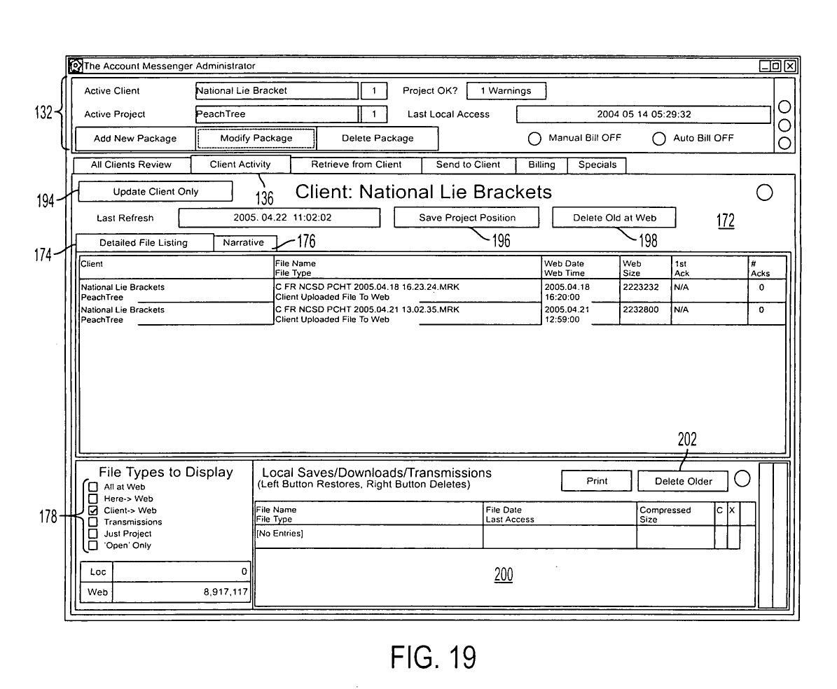

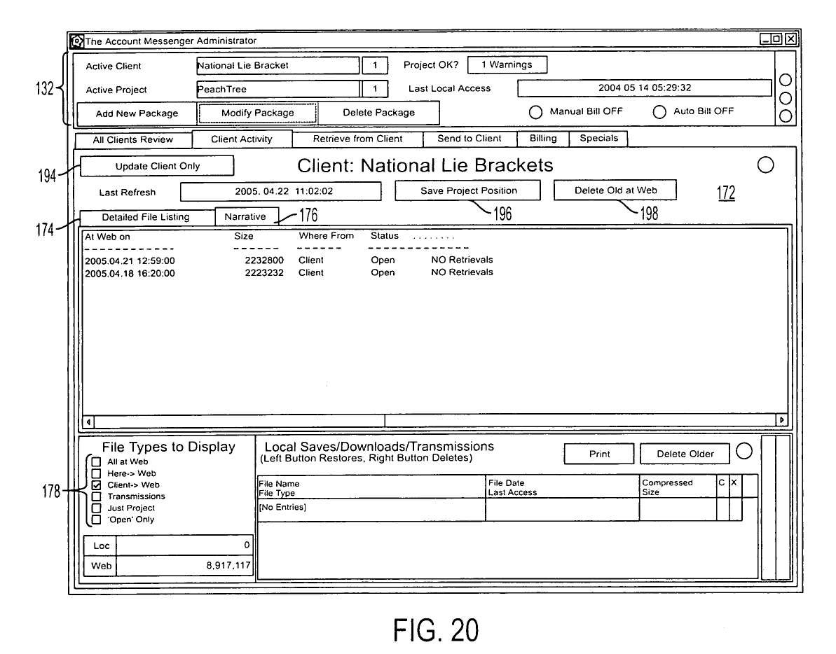

FIGS. 19 and 20 are illustrations of a professional user interface for a client according to an embodiment of the present invention.

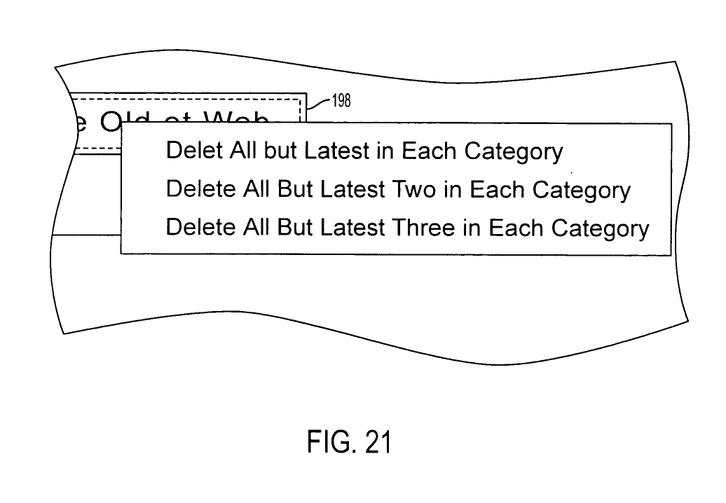

FIG. 21 is an illustration of a delete popup menu according to an embodiment of the present invention.

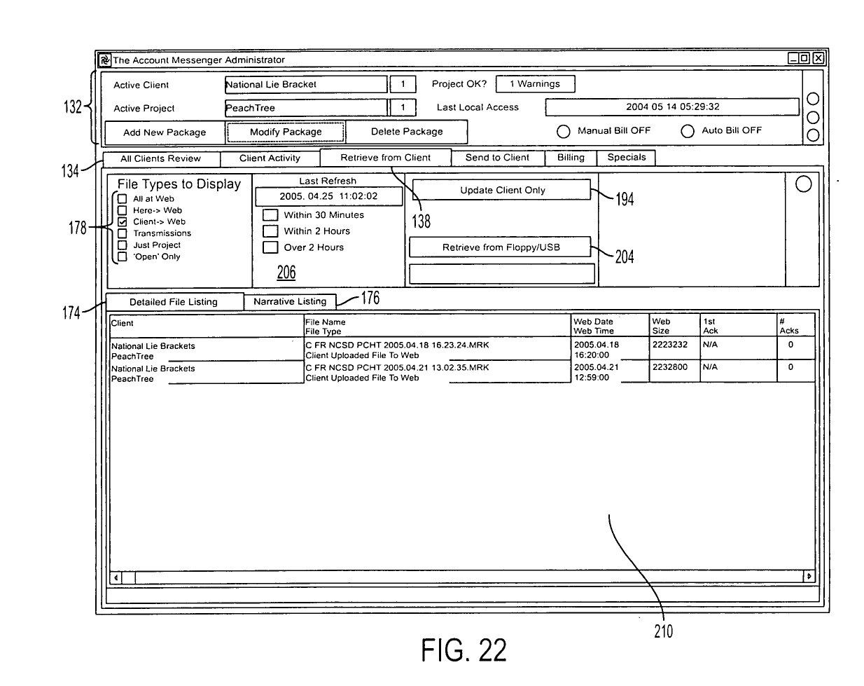

FIGS. 22 through 27 are illustrations of varying professional user interfaces when varying task-oriented tabs are displayed, according to an embodiment of the present invention.

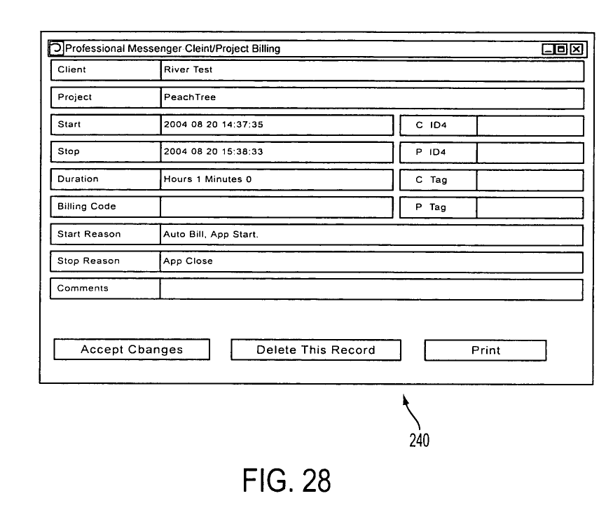

FIG. 28 is an illustration of a client/project billing screen according to an embodiment of the present invention.

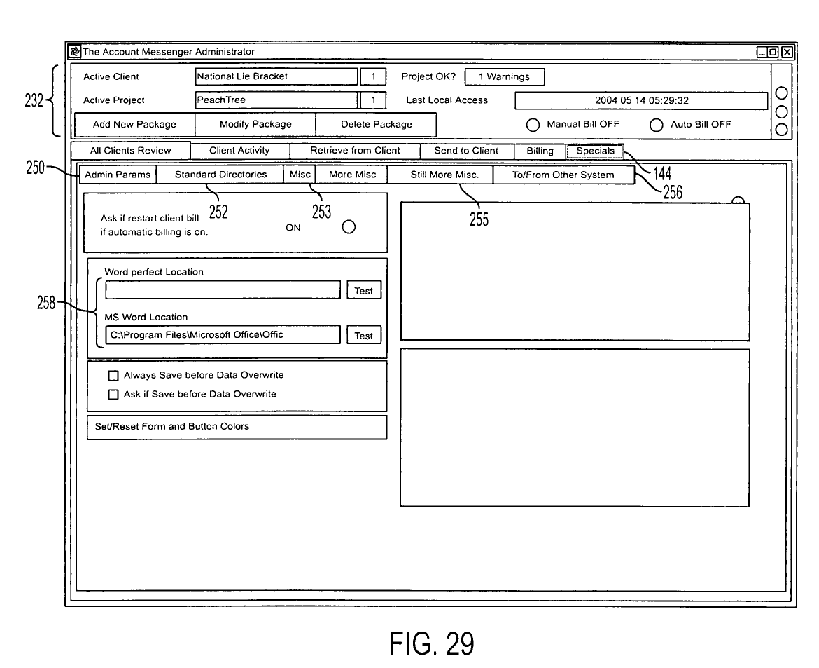

FIG. 29 is an illustration of a professional user interface for a selected task-oriented tab, according to an embodiment of the present invention.

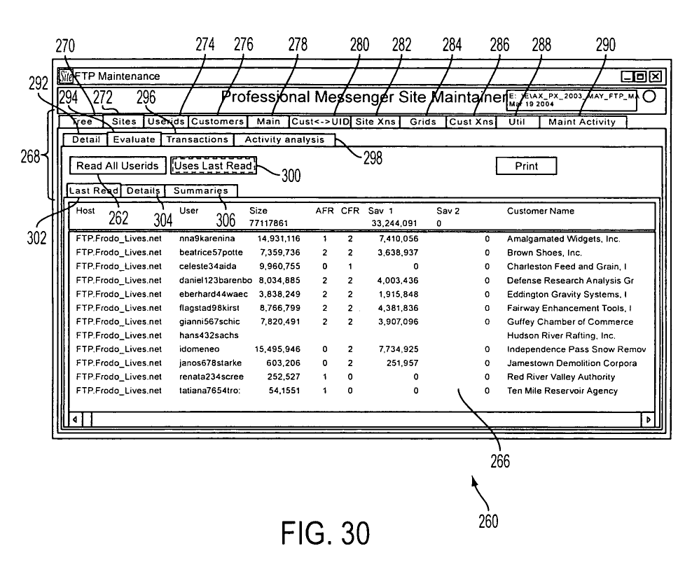

FIGS. 30 through 32 are illustrations of an administrative user interface according to an embodiment of the present invention.

### DETAILED DESCRIPTION OF EMBODIMENTS

The present invention is a system and method of simplified project data transfer between two or more users of the same or dissimilar application software. The invention provides users of an application working alternately on the same data in different locations with a fast, secure and reliable method of exchanging application data using desired software. In corporate environments where the data is not only confidential but also voluminous and scattered into many files and directories, the present invention is advantageous.

For example, the invention finds applicability in the accounting industry where accurate, repetitive exchange and backup of data in a secure way are important. Also highly valued is the simplification of transmission accounting/financial application data into a single keystroke. This makes the current invention user-friendly across a wide variety of users. For convenience, the invention is described from the perspective of three users, though not so limited.

In one embodiment of the present invention, use of the invention is described from the client-user perspective. In this scenario, the client is likely a busy proprietor or non-business user who may not be an expert on computers or has a busy schedule. In either case, efficiency on the computer is desired when using an accounting or financial software.

Accordingly, the client-user graphical user interface of the present invention is configured and simplified as shown in FIG. 1 to show the two heavily used functions in these programs in the form of buttons: a send button 4 and a receive button 6. The screen shot 2 also displays a menu bar 8, which provides options 10, utility 12 and helps 14 dropdown menus.

The utility menu 12 is oriented to functions of assistance by telephone help desk technicians, such as providing off-line, local loopback of FTP functions to isolate problems.

The help menu 14 provides entry for the invention's help system, which is preferably HTML based, in its dropdown menu. The help system is preferably a HTML based view of the help documentation having for example, a table of contents, index and keyword search capabilities.

The help system is also available in context by icons, which is preferably color coded, on the various (and other) screens herein described. Activating each help icon takes the user to the table of contents documentation of that section of the invention in the full help system.

The help menu 14 also provides an About menu feature, which provides release level information about the system of the present invention.

An example of the operational features that may be included in the options drop down menu 10 is shown in FIG. 2. These features were derived in part to address user complaints and frustrations with existing software and solve such issues in the user-friendliest way.

The upload/download feature 22 provides a listing, in detail or narrative format, of all transmission and retrieval acknowledgements at a particular FTP data location. FIG. 3, for instance, illustrates a screen shot 52 of such a listing, in detail format, for client project files preferably located at the project's FTP lockbox. Information on the web date, web time, web size and number of acknowledgements are provided.

The upload/download feature 22 is also useful to identify one or more transmissions previously sent by the client or to identify contact with a file by another user, such as a professional-user or authorized client-user. In addition, feature 22 may be used to retrieve one or more uploaded transmissions or files, such as to facilitate the transfer of data from one client system to another.

Clicking on any uploaded file entry shown in screen shot 52 activates display of a download options screen 54 as shown in FIG. 4. Screen 54 allows the user: via button 56 to save the current project data position, download a file and replace the current application data with the downloaded data; via button 58 to download the file and save the data such as for later viewing/handling; or via button 60 to download and save the file then copy the data to a desired computer readable medium, such as a floppy disk, CD/DVD, USB memory stick or the like.

The saves feature 24 in FIG. 2 shows all local saves and backups, including uploads and downloads, with no option of rolling back to anyone of them. See FIG. 8. In other words, inadvertent mouse clicks or touches on screen 62 in FIG. 5 does not cause data changes to a file.

The space management feature 26 basically allows a user to manage data space locally. It provides information on the status of backup and saved space used on the local system. FIG. 6, for instance, illustrates local space management information in screen 64. Screen 64 allows a user to delete older saves by the number of prior saves or generations in each save category (i.e. upload, download or local save). Other space used in the save directory may also be deleted using screen 64.

The save current position feature 28 in FIG. 2 simply saves the current package position with a unique name.

The rollback feature 30 functions like a back button. For example, when a file is downloaded and its data made current, and the user decides that was not the desired action, the user may employ the rollback feature 30 to roll back to the backup just before the data overwrite or other save(s).

The test connection feature 32 performs a series of diagnostic tests to ensure that all components of an FTP communication, for example, with the user's site are operating properly. The test connection feature 32 also takes the form of a button 32 as shown in FIG. 9.

The update feature 34 in FIG. 2 essentially reloads the FTP read cache. For the client user, this feature is rarely used.

The test e-mail feature 36 allows for the dispatch of test e-mails to the intended recipient as well as to the sender according to the e-mail addresses entered in the configuration parameters. Notably, the e-mail notification option must be turned on for this feature 36 to operate.

The current account status feature 38 in FIG. 2 simply provides information pertaining to the amount of space used/available at a FTP site and locally for backup storage. This feature 38 is helpful for trouble shooting activities.

The select new project feature 40 facilitates toggling between one or more previously configured projects. An exemplary project selection screen 66 that is displayed after selecting feature 40, is depicted in FIG. 7. If a project other than Nanometric Containers, Inc. is selected from screen 66, that project becomes the new active project for the client.

The active project feature 42 of FIG. 2 provides an overview of the template definitions of the active project. The template definitions screen 68 shown in FIG. 8 is exemplary, illustrating information relating to the client, the project, the FTP host and user, the directory and the software application. Screen 68 also provides diagnostics information for troubleshooting resolution.

The rescale feature 44 of FIG. 2 allows the user to reset size and various screen resolutions as desired.

Similarly, the set form colors feature 46 allows for the re-setting of form and screen control colors as desired.

The reset project directory feature 50 is a short cut feature that simply resets project data from one operative directory to another (i.e. from directory “f” to “g”) in one click. This is often the only action needed to update a local project definition (template) after a system re-configuration or upgrade, for instance, and it avoids input of other details via the project setup screen 70.

The project parameters feature 48 (FIG. 2) presents a (modal) project setup screen for input of project parameters. One example of a project setup screen 70 is depicted in FIG. 9.

For discussion purposes, a project refers to the name of a computer application, which may be any desired software that generates or saves or modifies data. If an application software manages distinct data sets for different entities, the present invention is capable of treating these as distinct projects. In the embodiment described herein, financial software is referenced such as Peachtree® and QuickBooks®, though not so limited. The present invention is applicable to other financial/data manipulation software as desired. The entire project description along with FTP parameters, encryption key information, owner information, comments and system parameters such as password(s), file location(s) and the like, refers to a package.

Referring now to FIG. 9, there is shown a package description for EOC Accounting, the package name. The comment box 72 provides, in part, project modification information. QuickBooks® is the specified project name 74 having a project ID 76 of QKBK. The sender is generally the owner of the data.

As depicted in FIG. 9, the sender name box 78 identifies Equipotent Orthogonalities Company having a sender ID 80 of EOC. The sender ID may comprise a string of three to seven alphanumeric characters and is used in file naming. Preferably, the sender ID is unique to the package name or the client.

FTP site definitional information, such as the FTP site/host and the FTP username, is also prompted for input on project setup screen 70. A third FTP site definitional requirement is a password, which is entered after depressing the set password button 82. The FTP account password is thereafter internally encrypted.

The select standard application button 84 provides two choices of projects; namely, Peachtree® and QuickBooks®. Alternatively and/or optionally, other choices may be made available as desired and added to the menu.

The encryption button 86 allows for the encryption of transmitted files. Encryption is customizable by entry of an allowed integer value by the user. The generated key is then stored in encrypted form. Alternatively and/or optionally, sophisticated users may supply their own encryption algorithm and keys.

The project template button 88 in FIG. 9 allows a user to define any set of data in different ways without regard to where the information is located. It facilitates the collection of data in accordance with desired selected elements of what the template should comprise.

For example, depressing project template button 88 presents a template definitions screen like the screen 68 shown in FIG. 8. As depicted, the elements of the template comprise selected information about the client (i.e. client name, identifier and tag), the project (i.e. project name, identifier and tag), the FTP (i.e. the FTP host and the FTP user), the directory (i.e. directory “e”), and the project (i.e. Peachtree® application). In other words, the project template button 88 takes the user through a series of menus that allows the user to choose a desired data source location, and builds a template specifying the algorithm that selects project data from a given directory as part of the project definition.

As earlier discussed, the test connection button 32 shown in FIG. 9 is used to test the proper transmission and receipt of a test file to the FTP site. A test failure here is usually a warning that the user's computer is not connected to the Internet or, most commonly, the existence of a spelling error in one of the three required FTP parameters. These errors are usually easily remedied by double-checking the FTP account specifications.

Depressing the summary button 90 presents the exemplary project building checklist or configuration review screen 92 shown in FIG. 10, summarizing the validity of all the project parameters entered at this point. As depicted, there is a problem with the project template, requiring further action at the project template button 88 in FIG. 9. There is also a problem with the FTP user password, requiring further action at the set password button 82 in FIG. 9.

In FIG. 10, two items in the project definition are flagged with question marks also. One is a note indicating that the encryption key is zero and, thus, likely not yet entered. And the other is a note that the FTP connection has not yet been tested; in other words, the FTP parameters have not been checked by operation use yet. This warning disappears after the first good FTP connection.

Depressing the save button 94 in FIG. 9 saves all of the entered parameters and closes the project setup screen 70. If the project setup screen 70 is exited without using the save button 94, the user is presented with a confirmation dialog about whether to save the data inputted so far. An exemplary confirmation dialog 96 is shown in FIG. 11. If the answer is no, none of the entered parameters are saved and the current settings for this project remains unchanged. If yes is selected, all the inputted data is saved and the current settings are modified accordingly.

Finally, in FIG. 9, the project setup screen 70 displays a menu bar 98, which provides more projects 100, collections 102, tools 104 and help 106 dropdown menus. An example of the operational features that may be included in the more projects drop down menu 100 is shown in FIG. 12. The first four options allows a user to define (or re-define) a project in another application other than Peachtree® or QuickBooks®; namely, Excel®, QuattroPro®, Word® and WordPerfect®. Other applications as desired may be added.

The save/swap option 108 allows for the backup and transfer of the parameters of all projects and supporting internal databases from the user's main system to one or more other systems. The transfer is facilitated by turning all such information into an upload file for specified use at a FTP location.

The CPPBuilder option 110 allows for the use of a project definition using a C++ compiler.

The download option 112 allows a user to download software and/or new releases or updates related to the system of the present invention.

The arbitrary project option 114 allows the user to define a set of project templates, name the templates, and place them on the more projects drop down menu 100 in FIG. 12 for instance.

Referring to FIG. 9, the collections menu 102 simplifies the setup and maintenance of multiple directory projects. For example, through use of the collections menu 102, a project may be setup using Excel® spreadsheets in one directory and Word® in another directory. Or, a project may be setup using Excel® files scattered among three different directories. Without the collections menu 102, a user defining a project having several standard application types (e.g., Excel® and Word® across one or more directories) would be required to enter the individual template definitions for each type and directory. With this option, the user simply selects the templates for the software types and specifies the directories via collections menu 102.

The tools menu 104 provides the capability of using alternate names and project descriptions for one or more of the actual project parameters. This allows generation of tutorials and help documentation, for instance, from live data without compromising confidentiality.

The help menu 106 provides easy access to the general help system of the invention, providing detailed contextual documentation of the various features.

The configuration parameters of the present invention, such as password(s), file location(s) and the like, are set at installation and generally do not need to be re-entered on each use. Passwords and encryption keys are preferably stored in encrypted form. An authorized user may modify each parameter at any time.

The simplicity of the graphical user interface 2 of FIG. 1 is advantageous because it does not require complicated relearning or consulting documentation. Once system parameters are initially entered and tested, which may be aided by telephone support, and the client-user desires to transmit the current project data, the user simply depresses the send button 4.

When the send button 4 is depressed, the current project data is saved with a unique name and the (modal) data transmit progress screen 15, as shown in FIG. 13, appears. Progress bars preferably show the progress of compression, both by percent of file count and proportion of total space to compress, the percent of encryption complete, and then the transmission, with a progress bar for percent of transmission complete. A histogram of speeds (moving from right to left) during the current time slice as well as incremental status returns during actual connection and transmission are also shown. On completion, this screen 15 disappears and the user is returned to the graphical user interface 2 in FIG. 1.

With respect to the retrieve data button 6, when it is depressed and no appropriate files are located at the FTP site, the user is notified by display of a warning dialog 116 as shown in FIG. 14. If appropriate files are located, the user is queried if the latest of these is the one desired. If so, the download proceeds and the current project data is saved with a unique name whereupon the data transfer progress screen 15 of FIG. 13 is displayed. Upon completion, screen 15 disappears and the user is returned to the main interface 2 in FIG. 1.

Lastly, with regards to FIG. 1, there is shown a history database icon 16, which when depressed or touched, provides the last recorded system event. Through the history database icon 16 every significant activity by a user is recorded. Exemplary activities that may be recorded in the history database include: session start time; session end time (normal and abnormal); project saves; uploads/downloads to/from FTP site; download from FTP site aborted by a user; begin and save project modify; delete saved file; upload/download backup file; add client; error recording; arbitrary comment; history database re-creation; save or download restore; empty site on read; FTP read all sites; FTP read one site; FTP bad/good connect; FTP test connect; FTP early disconnect; FTP decrypt fail.

The historical recording feature of the database icon 16 serves as an audit trail of transaction or activity events whether for tracking and/or usage and analysis purposes. This feature is also useful as technical support for telephone assistance.

Graphically, the historical feature may be presented as a history detail display screen 118, such as the one record of history shown in FIG. 15. This record shows a detail record 120 of a user login, as indicated by the action entry 126. Other information displayed in the detail record 120 include time stamp, client name and ID, the last access date, and a comment box, for example.

Additional history record information about the database grid may be obtained by clicking onto the DB grid tab 122. The DB maintenance tab 124 provides history analysis information on the database.

In a second embodiment of the present invention, use of the invention is described from the professional-user perspective. In this scenario, the general activity of the professional is to actively service each client with respect to the application project data and monitor the status of accounts for one or more clients. Here, the professional may be likened to a financial professional, such as an accountant, servicing multiple clients or other accountants, for example.

Because the professional interacts with clients and/or client data on an almost daily basis, and is generally familiar with the main options, the present invention is configured to present all of the professional user's options up front on task-oriented tab sheets or tabs rather than in dropdown menus. This is advantageous because constant menu chasing is frustrating to experienced users.

Accordingly, the professional-user graphical user interface 130 of the present invention is configured and simplified as shown in FIG. 16. This screen is preferably composed of a header sub-screen 132, which includes a variety of global options as discussed below, and six task-oriented tabs: all clients review 134, client activity 136, retrieve from client 138, send to client 140, billing 142 and specials 144.

Within sub-screen 132 is an active client option 146, which displays the name of the current client under view. The display of overall client information on screen 130, one client at a time, is persistent across stop and restart of the present invention. A different active client may be selected by clicking on the active client option 146, which activates display of the project selection screen 66 shown in FIG. 7. As earlier described, when a user clicks on a desired project package (i.e. Riverine Tautoligies, Inc.), that project package becomes the new active client.

Also within sub-screen 132 is a project status option 148, which indicates the number of unacceptable or questionable parameters. This information is gleaned from the left hand status column of configuration review screen 92 shown in FIG. 10. As indicated in FIG. 16, there is one project warning item.

The last local access option 150 indicates the most recent date and time of project files accessed on the system for an active client. The active project option 152 indicates the active application software for that client.

The option to create a new project is exercised by depressing the add new package button 154, which activates the display of the project setup screen 70 shown in FIG. 9 and previously discussed.

The package parameters for National Lie Bracket, the active client depicted in the header sub-screen 132 in FIG. 16, may be changed by clicking on the modify package button 156. Doing so brings up the project setup screen 70 of FIG. 9. In addition, a client may be removed from the system by clicking on the delete package button 158. Preferably, the client is removed only after a confirmation dialog is presented, prompting the user to confirm deletion.

The manual and automatic billing options 160, 162 is a status indication of whether those options are turned “on” or “off”. Here, as shown, both billing options 160, 162 are turned “off”. Preferably, these options are color coded to indicate whether the options are turned “on” or “off”.

Along the far right of sub-screen 132 in FIG. 16 are three circular icons, which are preferably color coded, representing short cuts to selected screens and information about the current client. For example, icon 164 displays an active project overview screen in the form of template definitions screen 68 of FIG. 8. This is useful especially to the help desk troubleshooter because screen 68 quickly shows the main project parameters and is made visible by a system-oriented option preferably not readily available to the user.

The second icon 166 displays a history detail screen 118 of FIG. 15, which shows the last recorded history record. The history feature serves as an audit trail, as well as its usage and analysis database, and support for telephone assistance.

Clicking on the third and final circular icon 168 in sub-screen 132 activates display of the help system, in the context of this part of the screen. In general, the help system is preferably a HTML based view of the documentation having, for example, a table of contents, index and keyword search capabilities. The help system icon 168 shortcuts the user to the table of contents section associated with a help sub-screen concatenating sub-screen 132.

Depressing the update all websites button 170 triggers the reading of file names and time stamps of all files for all client FTP lockboxes and, consequently, updates the FTP read cache. As depicted, the last refresh date was Apr. 22, 2005.

Discussion is now directed to the six task-oriented tabs beginning with the all clients review tab 134. Screen section 172, entitled “All Files at All Web Sites”, displays the contents of all client FTP lockboxes. Clicking or touching on a column (i.e. “client” or “file name”) in the top row will sort the grid on that column. Retouching the column title will sort the grid rows in the opposite direction. The columns show all client information in a detail mode 174. In other words, the columns show the client, file name and type, web (FTP) date and time, web size (i.e. the size of the file), instances of a first acknowledgement (i.e. when, if ever, it was retrieved by a client), and the number of acknowledgements (i.e. how many times the client retrieved the file).

To view this information in an alternative narrative format, the user need only click or touch the narrative tab 176. As illustrated in FIG. 17, the “At Web on” column provides transmission time stamp information. The “Client Name” column provides information on the name of the client. The “Size” column provides information on the size of the file. The “Where From” column identifies the sender of the information. And the “Status” columns indicate the status of the file. “Open” indicates that no retrieval information for this transmission is found. “No retrievals” indicate that the file has not been retrieved (by the client or administrator). If one or more retrieval records for the transmission is found, the transaction is depicted as “closed” and the time-stamp of the retrieval is preferably shown.

Referring again to FIG. 16, there is a checkbox control section 178, which determines which file types to display in screen section 172. Only one of the checkboxes may be checked, with the “All at Web” box preferably being the default. The checkboxes control which files found at the FTP site are shown. For example, “All at Web” option shows every file. “Here->Web” shows the current user's transmissions and whether they have been retrieved. “Client->Web” shows transmissions from the client and whether the current user has retrieved them. The “Transmissions Only” option is substantially identical to the “All at Web” option. The “Open Only” option shows non-retrieved project transmissions only. Notably, a user may select which file type to display in either the detail mode 174 (FIG. 16) or the narrative mode 176 (FIG. 17).

Screen portion 180 shows a project summary of all clients and various corresponding data, such as the client name, the project, last access data, local file size and web file size. Clicking on an entry in the client column will make the selected entry an active client. Also, clicking on column 182 activates display of a web space manager screen 186 as shown in FIG. 18. Screen 186 provides information on available space at a client's FTP. In addition, clicking or touching column 184 triggers display of a local space manager screen 64 (FIG. 6).

The print button facilitates the printing of information in screen sections 172 and 180. The help icons 188, 190, 192 activates a help system within screen sections 172, 178, 180, respectively, each within the context of the part of the screen that the icon is located.

The information displayed after clicking or touching client activity tab 136 is shown in FIG. 19. Here information about the files/status of a single active client only is provided. Accordingly, an update client only button 194 is provided for the reading of file names and time stamps of all files for the active client FTP lockbox and, consequently, the updating of the FTP read cache. As depicted, the most updated date is Apr. 25, 2005.

Screen section 172 in FIG. 19 shows similar types of file information as in FIG. 16. For example, FIG. 19 illustrates in screen section 172 information in a detail mode 174 and a narrative mode 176.

However, in FIG. 19, the file information is directed to a single client. Accordingly, there is a save project position button 196 in FIG. 19 that saves the current project data for the active client under a unique file name. There is also a delete old at web button 198 that, when depressed, activates a pop-up menu to delete older files at the FTP lockbox for the active client. The pop-up menu, as shown in FIG. 21, preferably provides three options; namely, to delete all but the latest files in each category; to delete all but the latest two files in each category; and to delete all but the latest three files in each category.

FIG. 20 shows the information in screen section 172 in narrative mode 176 where there have no retrievals for any of the two listed files.

Checkbox control section 178 in FIG. 19 is similar to section 178 in FIG. 16, except for the addition of a “just project” option. Both “Just Project” and “Open Only” options may be checked independently from the other four checkboxes options. The “Just Project” option shows only the active project transmissions, if the FTP site has multiple projects for the same user, whereas the “Open Only” options shows non-retrieved project transmissions only.

Screen section 200 shows all local saves—whether an explicit save or a backup of an upload or download—for the active client. Section 200 is preferably identical to the screen 62 of FIG. 5. To the bottom left of screen section 200 indicates the local and web space used for the active client. The delete older button 202 in screen section 200 activates display of local space manager screen 64 in FIG. 6. Button 202 automatically deletes all but the most recent three transactions of each kind (i.e. upload backup save, download backup save, and manual save) in the project save directory.

Referring now to FIGS. 22, 23 and 4, the information displayed in FIG. 22 is provided by selecting the retrieve from client tab 138. Clicking on any one of the two client entries in screen section 210 in FIG. 22 will prompt the display of the download options screen 54 of FIG. 4, as earlier discussed.

One difference between FIG. 22 and FIG. 16, for example, is the addition of a retrieve from floppy button 204, which facilitates the retrieval of saved project data on a floppy disc or USB or external device.

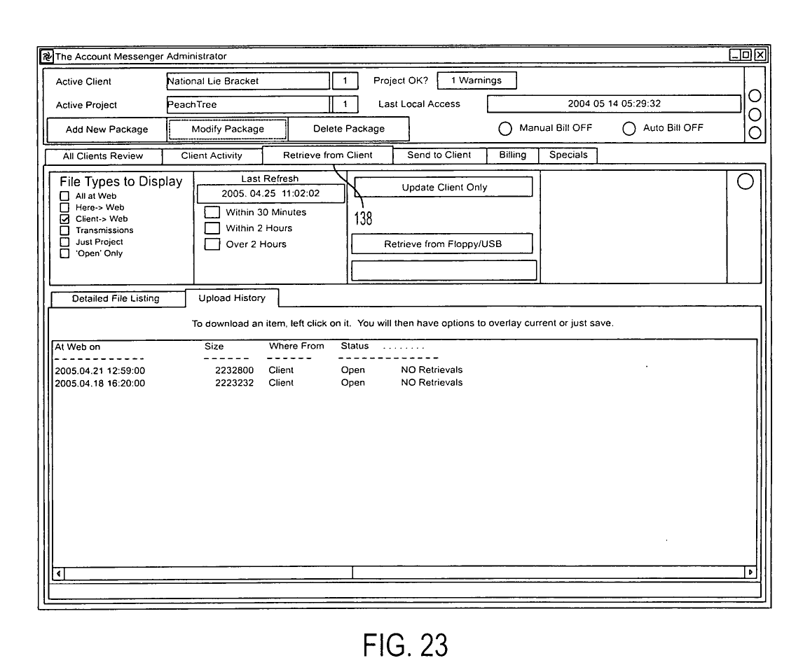

Another difference in FIG. 22 is screen section 206, which provides the user with a legend, preferably color coded, denoting the colors used for the background of the last retrieval time-stamp; for instance, green for the last 30 minutes, orange for the last 2 hours, and red for 2 hours or more. Again, FIG. 22 displays client information in a detail mode 174 whereas FIG. 23 displays information in a narrative mode 176.

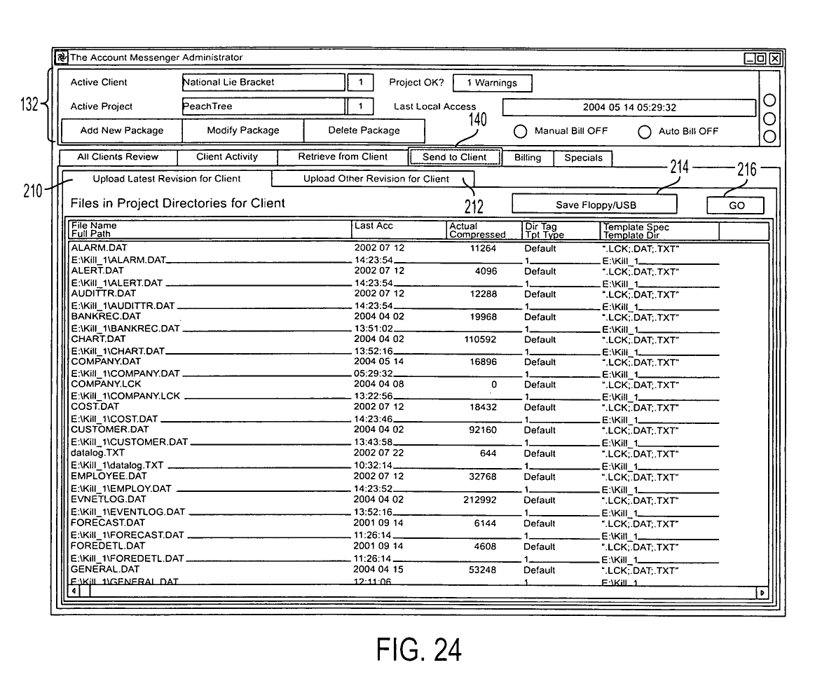

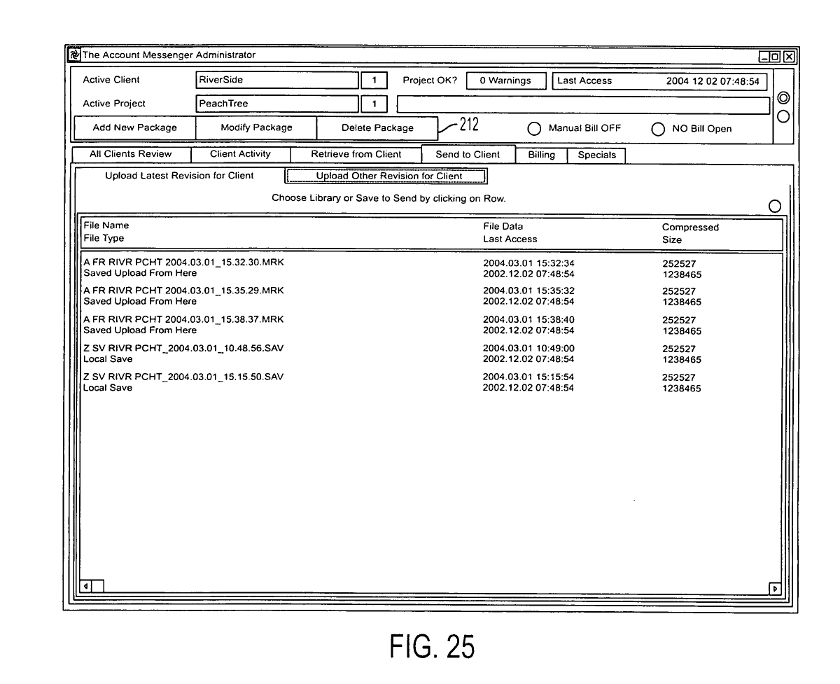

Referring now to FIGS. 24 and 25, there is shown information displayed when the fourth task-oriented send to client tab 140 is activated. More specifically, FIG. 24 shows the current project files for a client per tab 210, and FIG. 25 shows other revision upload(s) for a client per tab 212. To send the current data in FIG. 24, the user clicks or touches the go button 216.

The save floppy tab 214 saves the current project data to a floppy disk, USB memory stick or such external memory device. Through this feature, the present invention may save a file to any locally accessible file. This feature is also useful for copying a project's data from one system to another not necessarily networked system via removable storage.

In the event that a user wishes to send another project file, such as a previous save or a prior download or any desired version of the data available in the save format of the invention, such as depicted in screen section 200 in FIG. 19, tab 212 in FIG. 25 presents a list of such files. Clicking on any one of the row entries in FIG. 25 uploads that file after a confirmation dialog.

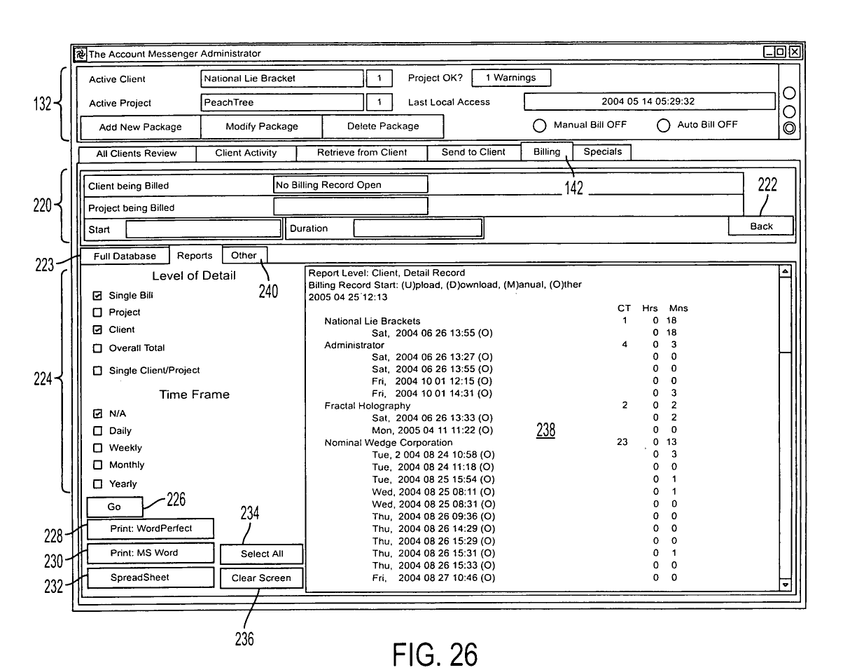

Selecting the billing tab 142 displays the information provided in FIG. 26. The billing header section 220 provides information about the client and project being billed, if any, and the start and duration of the billing cycle. The back button 222 returns the user to the last used tab on the screen prior to the billing tab.

The reports screen portion 224 in FIG. 26 provides billing summary options by level of detail and time frame. Billing summary options by level of detail preferably include billing individually, by project, by client or overall total. For example, if single client/project box is checked, the billing report is restricted to the active client only. Billing options by time frame allows for the reporting of bills on various periods, such as daily, weekly, monthly and yearly.

Selecting the go button 226 generates a billing report shown in FIG. 28. Selecting print buttons 228, 230 will generate printing of the billing report in WordPerfect® or Word®, respectively, if these applications are available at the user's system. Selecting the spreadsheet button 232 creates a Comma Separated Variable (CSV) file of the report. Choosing button 234 preferably copies the currently generated report onto a clipboard window, such as a Windows® clipboard, for later use or inclusion in an e-mail, for example. And button 236 clears the screen.

The full database screen section 238, which is activated by selecting tab 223, lists the detail billing records for the active client. It shows a full grid of client data. Selecting one of the row entries in screen section 238 activates a bill review screen 240 as shown in FIG. 28.

The bill review screen 240 provides client/project billing information, such as client name, project name, billing start/stop/duration times, start reason, stop reason as well as a billing code. Preferably, the user may modify or delete one or more elements of the billing record, such as through the use of buttons. Optionally, the user may print a copy of the record.

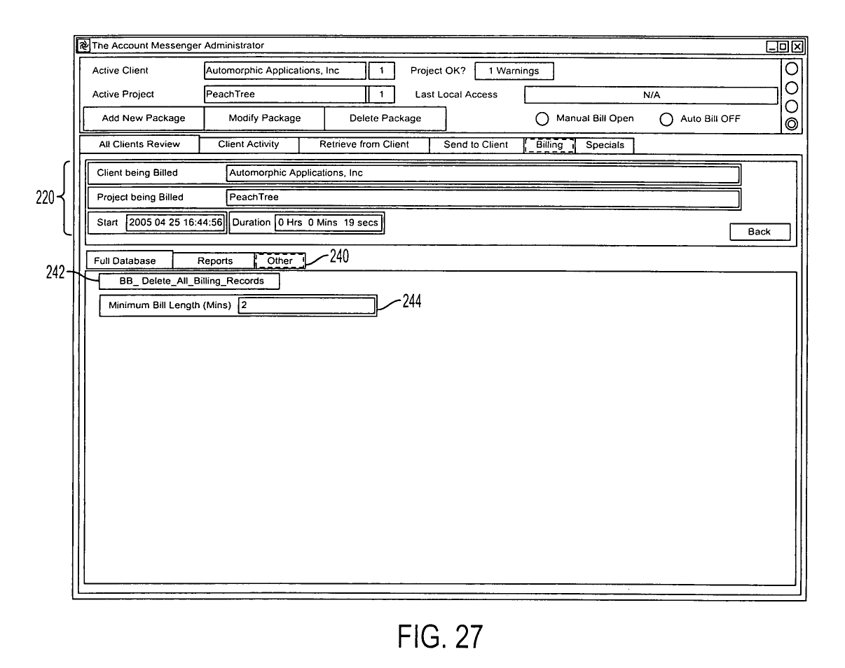

Other billing database maintenance and/or billing parameters issues may be addressed through another tab 240 as depicted in FIG. 27. For example, the entire billing database may be initialized via button 242, and preferably after prompting by a confirmation dialog. The user may also set a minimum time requirement to automatically record a billing record based on the length of time only, such as through use of an automatic billing feature 244. Alternatively and/or optionally, a user may set a minimum time to record a billing using automatic billing where each active client has a bill started on selection as an active client, and each client has a bill closed on selection on another active client. Establishing minimums aids in preventing trivial billing records from being generated.

The sixth and final task-oriented tab is the specials tab 144. Clicking on the admin tab 250 displays the screen information provided in FIG. 29 and provides selected options to the user such as, for example: whether to restart or continue a client bill if that bill was open when the last session ended; in screen section 258, the ability to define what the desired system location for word processing packages on the system are; whether to query before data overwrite on download or restores, querying preferably being the default; whether to save project position before data overwrite, saving preferably being the default; and the ability to set desired color(s) for the forms and buttons of the system.

The standard directories tab 252 allows a user to specify default directories for application types so that the template definition directory selection begins at these directories.

The misc tabs 253, 254, 255 are help desk oriented features showing certain information. For example, tab 253 shows information on application build date and relevant installation directories. The ability to re-size one or more forms and change font size is also located in the misc tab 253. Tab 254 shows additional information including cache read time-stamps and project templates in various formats. Tab 255 shows even further additional information including which applications are active on the system of the present invention. The other system tab 256 handles movement of the full database of all clients information to another system, such as to a laptop.

In a third embodiment of the present invention, use of the invention is described from a space manager or administrator-user perspective. This perspective of the invention provides a space manager with tools for administering FTP lockbox space used by a client-user and/or professional-user, as well as analysis tools to guide the manager in FTP space rental and allocation. It also provides reporting tools useful to the administrator or space manager in understanding how clients use the system as well as the turnaround time from client submission to retrieval by a client. It further provides the manager with system tools for tracking usage billing and other charges to the users of the space managed.

In particular, this perspective of the invention allows a space manager, for example, to review appropriate lockboxes and current space use for each lockbox or project.

Referring to FIG. 30, there is shown an exemplary FTP review screen 260, which lists the total space used for each lockbox. More particularly, screen section 266 shows a summary of the transmitted files present at each FTP lockbox under management. As depicted, the summary information available for viewing includes the name of the FTP host, the user's ID, file size, the number of project files from the administrator (denoted by AFR), the number of files from the client (denoted by CFR), space used, if any, for first generation of data previous to the latest (denoted by Sav 1), space used, if any, for second generation transmissions (denoted by Sav 2) and the customer/client name.

Thus, by selecting the read all userid button 262, screen 260 not only allows a space manager to view all FTP sites at once, but also view space used by the next transmission previous for each transmission type, and space used by the transmission type previous to that. Button 262 physically reads all managed FTP sites and presents screen section 266.

If a space manager desires to delete a prior generation of transmissions for a lockbox, the user selects a row entry in screen 260. Selecting or clicking on a non-zero field in the Save 2 column in screen section 266 triggers for display a web space manager screen 186 like the one shown in FIG. 18, preferably showing all files for the client with the Save 2 (or second generation transmissions) files highlighted, with the option of deleting the highlighted entries all at once, if the user is online. The highlighted files are preferably shown in color, such as an aqua color. If all the highlighted entries are to be deleted, the user touches or clicks the delete aqua button 264. If desired, the user may delete any single file by selecting that line or row entry, preferably after accepting a confirmation dialog.

Selecting or clicking on a non-zero field in the Save 1 column in screen section 266 of FIG. 30 triggers for display a web space manager screen 186 like the one shown in FIG. 18, preferably showing all files for the current client with the Save 1 and Save 2 (or first and second generation transmissions) files highlighted, with the option of deleting the highlighted entries all at once, if the user is online.

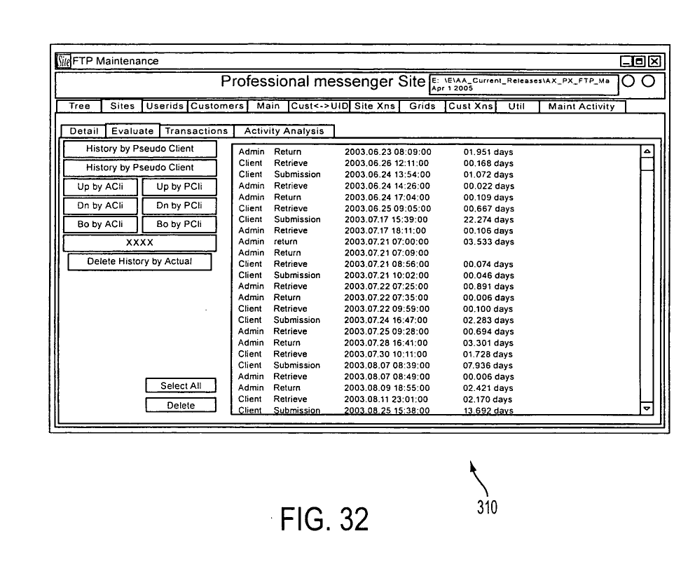

The FTP review screen 260 in FIG. 30 also provides additional information through the use of tabs located across its header section 268. For example, selecting the tree tab 270 provides information about the project data in a graphical tree format. The sites tab 272 provides information related to FTP sites to be managed without reference to other client information, such as contact and billing information. The userid tab 274 shows available lockboxes with assignments, if any, and the space allocated for each lockbox. The customers tab 274 provides customer information including contact information, account billing status and allocated lockboxes. The main tab 278 shows overall status of the system of the present invention including, for example, the number of installs, revenue and outstanding invoices. The cust tab 280 handles assignment of lockboxes and parameters to customers. The site xns tab 282 shows billing transactions related to FTP lockbox space vendors. This is distinct from the information in the customer tab 276 in that a customer may use space rented from more than one supplier; such information is presented in site xns tab 282. The grids tab 284 provides access to the database grid of each database in the space manager side of the system of the present invention. The cust xns tab 286 provides access to detail billing transaction records of customers. The util tab 288 provides access to system settings for the site maintainer system for individual lockboxes, such as FTP timeout and retry settings, active/passive settings, form colors, and handling pseudo FTP loopback testing. Selecting the maint activity tab 290 activates display of the tabsheet shown in screen 360 of FIG. 32 described further below.

The details tab 292 in header section 268 of screen 260 in FIG. 30 handles the FTP site parameters of an FTP lockbox including handling the addition and/or modification and/or removal of a site from active space management.

Selecting (clicking or touching) the evaluate tab 294 activates display of screen 260. The transactions tab 296 presents upload and download information of various clients in a detail format. The activity analysis tab 298 presents transmissions analyses by turnaround time showing, for example, client-to-admin retrieval time for uploads and client-to-admin-to-client total cycle times.

The use last read tab 300 presents the results of the last physical read from the read cache for off-line examination, preferably using the same screen section 266. The last read tab 302 presents screen section 266.

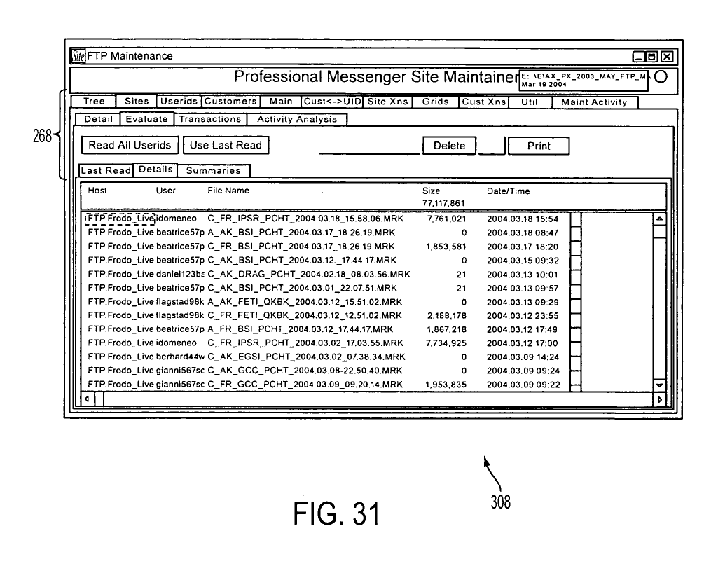

Selecting details button 304 activates display of a FTP file transaction screen 308 shown in FIG. 31, which shows each file at all lockboxes under space management. Selecting or clicking on the header of each column sorts that column, alternately in ascending or descending order. By clicking on a row, the user may conveniently also delete that file from its FTP lockbox, preferably after prompting by a confirmation dialog.

The summaries tab 306 shows overall totals on the number of files uploaded from clients and the administrator, as well as totals on the number of previous generations of uploads.

FIG. 32 shows a site turnaround history screen 310, by pseudo client, for both uploads and downloads. For example, sender name and ID may be replaced with aliases in generating documents without revealing client names, a helpful feature for blind reporting purposes. Information such as the time it takes to retrieve/submit/return client data, whether by the client or administrator, is provided by screen 310. FIG. 32 also shows that a report may be restricted to the turnaround of various transmission types.

The weekly analysis tab shows weekly data by managed customer. The efficiency tab provides overall client/administrator efficiency information, such as turnaround time, by client project submission. The bytes/sec tab shows various speeds of uploads and downloads and is related to lockbox usage efficiency rather than client/administrator efficiency. The by pseudo tab presents various analyses by customer and transmission type, on an actual or pseudo customer name basis (as depicted by screen 310). The “up by” and “Dn by” buttons provides upload and download information, respectively, by actual client name (denoted by “Acli”) or by pseudo client name (denoted by “Pcli”). The “Delete History” button shows when a project file was deleted by the site maintainer system. The deletion time-stamp is maintained to evaluate duration of project transmissions at the FTP lockboxes.

The circular icon in the top far right corner of screen 310 provides access to event history information of the site maintainer system, similar to the client side and administrator side event history.

The present invention may be customizable by a user who, for example, handles the installation for the professional-user and client-user. (This may be an administrator.) In other words, the encryption algorithm may be replaced, the allowed space for each lockbox may be set, and one or more project definitions may be standardized or added. (See FIG. 12). In addition, other parameters, such as the FTP timeout setting, may also be specified as desired.

The present invention is configurable to operate on personal computers preferably running the Microsoft Windows® operating system, such as Windows 98 or later. Preferably, the system of the present invention employs electronic networked or Internet connectivity and a FTP lockbox provided for each user. While several users and projects may operate through the same lockbox, it is not the preferred method. A lockbox may be provided by a user or a third party.

An embodiment of the present invention is implementable as computer software in the form of computer readable code executed on a general purpose computer or computer program product, and in a computer programming language executable on one or more operating systems. A computer program product includes any medium configured to store or transport or transmit computer readable code or in which such code may be embedded. Examples of computer program products include CDs, DVDs, floppy disks, ROM cards, magnetic tapes, computer hard drives, servers on a network, carrier waves and the like.

The above description and drawings are only illustrative of preferred embodiments that achieve the features and advantages of the present invention, and it is not intended that the present invention be limited thereto. The many features and advantages of the invention are apparent from the detailed specification. It is intended by the appended claims to cover all such features and advantages of the invention that fall within the spirit and scope of the invention. Further, since numerous modifications and variations will readily occur to those skilled in the art, it is not desired to limit the invention to the exact construction and operations illustrated and described. Accordingly, all suitable modifications and equivalents may be resorted to as falling within the scope of the invention.

1. A computer program product for project data transfer, comprising a computer readable medium having program instructions for:
receiving input from a client user that allows said user to build one or more project templates specifying an algorithm to select project data from a desired directory as part of a project definition;
creating a client user interface to send and retrieve project data, including upload, download, save, backup and local space management features;
receiving input from a professional user that allows this user through task-oriented tabs to service the accounts of one or more clients by at least one of choosing a desired data source location and collecting data using a project template;
creating a professional user interface having options more robust than said client user interface including task-oriented tabs for manipulating and displaying customer and project information in at least one of detail mode or narrative mode;
receiving input from an administrative user that allows this user through automatic space and transmissions management to maintain desired levels of backup information at one or more client, professional and file transfer protocol (FTP) sites; and
creating an administrative user interface distinct from the professional and client user interfaces for the handling of overall system and space management.

2. The computer program product of claim 1 having further instructions for instantiating automatic recovery attempts from transmission problems involving user intervention.

3. The computer program product of claim 1 having further instructions for receiving user input to generate a user defined encryption process for at least one of professional and client users.

4. The computer program product of claim 1 having further instructions for generating an email notification to at least one of a receiving or sending party upon transmission to or retrieval of information from a FTP site.

5. The computer program product of claim 1 having further instructions for the transfer of project parameters and one or more supporting databases from one system to another.

6. The computer program product of claim 1 having further instructions for automatic backup of project parameters and one or more supporting databases.

7. The computer program product of claim 1 having further instructions for providing a professional user with a notification of a configuration change by a client user system.

8. The computer program product of claim 1 having further instructions for providing system usage analysis to the professional and administrative users by each client user.

9. An electronic system for project data transfer, said electronic system comprising an information retrieval system, which comprises instructions for:
setting up project definitions and parameters during installation;
setting up space management parameters for each installation;
creating one or more configuration interfaces for each user comprising one of a client and professional;
providing detailed analysis and review of data exchange with a user comprising one of a client, professional or administrator;
error diagnosis and correction including error recovery and rollback of all project data transfers; and
automatic backup of interactions between one or more users.

10. The system of claim 1 further including one or more system upgrade releases.
